(19) United States
(12) Patent Application Publication
(10) Pub. No.: US 2018/0282165 A1
(43) Pub. Date: Oct. 4, 2018

(54) METHOD OF FORMING A MULTILAYER STRUCTURE

(71) Applicant: Rohm and Haas Electronic Materials LLC, Marlborough, MA (US)

(72) Inventor: Deyan Wang, Hudson, MA (US)

(21) Appl. No.: 15/912,832

(22) Filed: Mar. 6, 2018

Related U.S. Application Data
(60) Provisional application No. 62/477,468, filed on Mar. 28, 2017.

(51) Int. Cl. C01B 32/205; C09D 5/20; C09D 1/00; C09D 5/24; H01G 11/32; H01M 4/587; H01M 4/133; H01M 10/0525

(52) U.S. Cl. CPC C01B 32/205; C09D 5/20; C09D 1/00; C09D 5/24; C01P 2006/40; H01M 4/587; H01M 4/133; H01M 10/0525; H01G 11/32

(57) ABSTRACT

Compositions comprising a liquid carrier and certain MX/graphitic carbon precursors are useful in forming multilayer structures having an MX layer and a graphitic carbon layer disposed on a substrate, wherein the MX layer is interposed between the substrate and the graphitic carbon layer in the multilayer structure.

The present invention relates to the field of conductive materials. More particularly, the present invention relates to the field of graphene and its use in electronics applications.

Since successfully being separated from graphite in 2004 using tape, graphene has been observed to exhibit certain very promising properties. For example, graphene was observed by researchers at IBM to facilitate the construction of transistors having a maximum cut-off frequency of 155 GHz, far surpassing the 40 GHz maximum cut-off frequency associated with conventional silicon based transistors.

Graphene materials may exhibit a broad range of properties. A single layer graphene structure has a higher heat and electric conductivity than copper. A bilayer graphene exhibits a band gap that enables it to behave like a semiconductor. Graphene oxide materials have been demonstrated to exhibit a tunable band gap depending on the degree of oxidation. That is, a fully oxidized graphene would be an insulator, while a partially oxidized graphene would behave like a semiconductor or a conductor depending on its ratio of carbon to oxygen (C/O).

The electric capacitance of a capacitor using graphene oxide sheets has been observed to be several times higher than a pure graphene counterpart. This result has been attributed to the increased electron density exhibited by the functionalized graphene oxide sheets. Given the ultra thin nature of a graphene sheet, parallel sheet capacitors using graphene as the layers could provide extremely high capacitance-to-volume ratio devices, i.e., super capacitors. To date, however, the storage capacities exhibited by conventional super capacitors has severely limited their adoption in commercial applications where power density and high life cycles are required. Nevertheless, capacitors have many significant advantages over batteries, including shelf life. Accordingly, a capacitor with an increased energy density and without diminishing either power density or cycle life, would have many advantages over batteries for a variety of applications. Hence, it would be desirable to have high energy density/high power density capacitors with a long cycle life.

Liu et al. (U.S. Pat. No. 8,835,046) disclose self assembled multilayer nanocomposites of graphene and metal oxide materials. Specifically, Liu et al. disclose an electrode comprising a nanocomposite material having at least two layers, each layer including a metal oxide layer chemically bonded directly to at least one graphene layer wherein the graphene layer has a thickness of about 0.5 nm to 50 nm, the metal oxide layers and graphene layers alternatingly positioned in the at least two layers forming a series of ordered layers in the nanocomposite material.

Commonly assigned International Patent Application Serial. No. PCT/CN15/091039 (Wang et al.), filed Sep. 29, 2015, discloses a solution borne process using certain graphitic carbon precursors for forming multilayer structures comprising a graphitic carbon layer. While such process is effective to form a multilayer structure, there remains a need for graphitic carbon precursors that are relatively less expensive, have relatively improved solubility in the solvents used, and have a relatively higher content of polycyclic aromatic moieties.

There also remains a continuing need for methods of making graphitic multilayer structures comprising alternating layers of MX material (e.g., metal oxide) and graphitic carbon material for use in a variety of applications including as electrode structures in lithium ion batteries and in multilayer super capacitors.

The present invention provides a composition comprising: a liquid carrier; and one or more MX/graphitic carbon precursors of the formula (1)

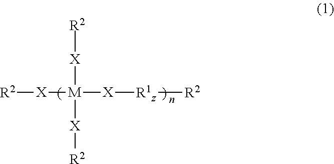

wherein each M is selected from the group consisting of Ti, Hf and Zr; each X is independently selected from the group consisting of N(R), S, Se and O; each R is selected from the group consisting of H and a —C₁₋₁₀ hydrocarbyl group; each R¹ is a —C₂₋₆ alkylene-X— group; z is 0 to 5; n is 1 to 15; each R² is independently selected from the group consisting of hydrogen, a —C₁₋₂₀ organic residue, a —C(O)—C₁₋₂₀ hydrocarbyl group, and a —(Y¹)ₐ-(L¹)_{b}-(Y²)_{c}-(L²)_{d}-C₁₀₋₆₀ polycyclic aromatic moiety; each Y¹ and Y² is independently selected from the group consisting of —C(O)— and —S(O)₂—; each L¹ and L² is independently a —C₁₋₁₀ hydrocarbyl group; a=0 or 1; b=0 or 1; c=0 or 1; and d=0 or 1; provided that d=0 when c=0; wherein at least one of b and d=1 when Y¹═—C(O)— or when a=c=0; and wherein at least 10 mol % of the R² groups in the MX/graphitic carbon precursor material are —(Y¹)ₐ-(L¹)_{b}-(Y²)_{c}-(L²)_{d}-C₁₀₋₆₀ polycyclic aromatic moieties. Also provided by the present invention is an electronic device comprising such multilayered structure.

The present invention further provides a method of forming a multilayer structure, comprising: providing a substrate; providing a coating composition, comprising: a liquid carrier and one or more MX/graphitic carbon precursors having a formula (1)

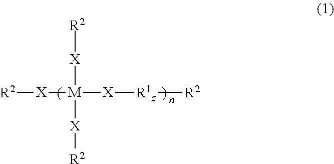

wherein each M is selected from the group consisting of Ti, Hf and Zr; each X is independently selected from the group consisting of N(R), S, Se and O; each R is selected from the group consisting of H and a —C₁₋₁₀ hydrocarbyl group; each R¹ is a —C₂₋₆ alkylene-X— group; z is 0 to 5; n is 1 to 15; each R² is independently selected from the group consisting of hydrogen, a —C₁₋₂₀ organic residue, a —C(O)—C₁₋₂₀ hydrocarbyl group, and a —(Y¹)ₐ-(L¹)_{b}-(Y²)_{c}-(L²)_{d}-C₁₀₋₆₀ polycyclic aromatic moiety; each Y¹ and Y² is independently selected from the group consisting of —C(O)— and —S(O)₂—; each L¹ and L² is independently a —C₁₋₁₀ hydrocarbyl group; a=0 or 1; b=0 or 1; c=0 or 1; and d=0 or 1; provided that d=0 when c=0; wherein at least one of b and d=1 when Y¹═—C(O)— or when a=c=0; and wherein at least 10 mol % of the R² groups in the MX/graphitic carbon precursor material are —(Y¹)ₐ-(L¹)_{b}-(Y²)_{c}-(L²)_{d}-C₁₀₋₆₀ polycyclic aromatic moieties; disposing the coating composition on the substrate to form a composite; optionally, baking the composite; annealing the composite under a reducing atmosphere; whereby the composite is converted into an MX layer and a graphitic carbon layer disposed on the substrate providing the multilayer structure; wherein the MX layer is interposed between the substrate and the graphitic carbon layer in the multilayer structure.

Also provided by the present invention is a method of making a freestanding graphitic carbon sheet, comprising: providing a substrate; providing a coating composition, comprising: a liquid carrier and one or more MX/graphitic carbon precursors having a formula (1)

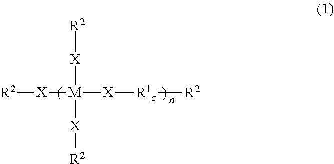

wherein each M is selected from the group consisting of Ti, Hf and Zr; each X is independently selected from the group consisting of N(R), S, Se and O; each R is selected from the group consisting of H and a —C₁₋₁₀ hydrocarbyl group; each R¹ is a —C₂₋₆ alkylene-X— group; z is 0 to 5; n is 1 to 15; each R² is independently selected from the group consisting of a hydrogen, a —C₁₋₂₀ organic residue, a —C(O)—C₁₋₂₀ hydrocarbyl group, and a —(Y¹)ₐ-(L¹)_{b}-(Y²)_{c}-(L²)_{d}-C₁₀₋₆₀ polycyclic aromatic moiety; each Y¹ and Y² is independently selected from the group consisting of —C(O)— and —S(O)₂—; each L¹ and L² is independently a —C₁₋₁₀ hydrocarbyl group; a=0 or 1; b=0 or 1; c=0 or 1; and d=0 or 1; provided that d=0 when c=0; wherein at least one of b and d=1 when Y¹═—C(O)— or when a=c=0; and wherein at least 10 mol % of the R² groups in the MX/graphitic carbon precursor material are —(Y¹)ₐ-(L¹)_{b}-(Y²)_{c}-(L²)_{d}-C₁₀₋₆₀ polycyclic aromatic moieties; disposing the coating composition on the substrate to form a composite; optionally, baking the composite; annealing the composite under a reducing atmosphere whereby the composite is converted into an MX layer and a graphitic carbon layer disposed on the substrate providing a multilayer structure; wherein the MX layer is interposed between the substrate and the graphitic carbon layer in the multilayer structure; exposing the multilayer structure to an acid; and, recovering the graphitic carbon layer as the freestanding graphitic carbon sheet.

It will be understood that when an element is referred to as being “adjacent” to or “on” another element, it can be directly adjacent to or on the other element or intervening elements may be present therebetween. In contrast, when an element is referred to as being “directly adjacent” or “directly on” another element, there are no intervening elements present. It will be understood that although the terms first, second, third, etc. may be used to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

As used throughout this specification, the following abbreviations shall have the following meanings, unless the context clearly indicates otherwise: ° C.=degree Celsius; g=gram; ppm=part per million by weight unless otherwise noted; cm=centimeter; μm=micron=micrometer; mm=millimeter; Å=angstrom; L=liter; mL=milliliter; sec.=second; min.=minute; hr.=hour; and Da=dalton. All amounts are percent by weight and all ratios are molar ratios, unless otherwise noted. All numerical ranges are inclusive and combinable in any order, except where it is clear that such numerical ranges are constrained to add up to 100%. Unless other wise noted, “wt %” refers to percent by weight, based on the total weight of a referenced composition. The articles “a”, “an” and “the” refer to the singular and the plural. As used herein, the term “and/or” includes any and all combinations of one or more of the associated listed items. M_{w} refers to weight average molecular weight and is determined by gel permeation chromatography (GPC) using polystyrene standards.

As used throughout the specification, the term “alkyl” includes linear, branched and cyclic alkyl. The term “alkyl” refers to an alkane radical, and includes alkane monoradicals, diradicals (alkylene), and higher-radicals. The term “alkylene” includes “alkylidene”. If no number of carbons is indicated for any alkyl or heteroalkyl, then 1-12 carbons are contemplated. The term “heteroalkyl” refers to an alkyl group with one or more heteroatoms, such as nitrogen, oxygen, sulfur, phosphorus, replacing one or more carbon atoms within the radical, for example, as in an ether or a thioether. The term “alkenylene” refers to linear, branched and cyclic divalent alkene radicals, unless otherwise specified. “Organic residue” refers to the radical of any organic moiety, which may optionally contain one or more heteroatoms, such as oxygen, nitrogen, silicon, phosphorus, and halogen, in addition to carbon and hydrogen. An organic residue may contain one or more aryl or non-aryl rings or both aryl and non-aryl rings. The term “hydrocarbyl” refers to a radical of any hydrocarbon, which may be aliphatic, cyclic, aromatic or a combination thereof, and which may optionally contain one or more heteroatoms, such as oxygen, nitrogen, silicon, phosphorus, and halogen, in addition to carbon and hydrogen. The hydrocarbyl groups may contain aryl or non-aryl rings or both aryl and non-aryl rings, such as one or more alicyclic rings, or aromatic rings or both alicyclic and aromatic rings. When a hydrocarbyl group contains two or more alicyclic rings, such alicyclic rings may be isolated, fused or spirocyclic. Alicyclic hydrocarbyl groups include single alicyclic rings, such as cyclopentyl and cyclohexyl, as well as bicyclic rings, such as dicyclopentadienyl, norbornyl, and norbornenyl. When the hydrocarbyl group contains two or more aromatic rings, such rings may be isolated or fused. The term “hydrogen” as used herein also includes isotopes of hydrogen such as deuterium and tritium.

Compositions of the present invention are useful in forming multilayer structures comprising alternating layers of MX and graphitic carbon. These multilayer structures may provide certain key components for energy storage devices with improved performance properties, wherein the multilayer structures provide high efficiency/high capacity energy storage in multilayered super capacitors and low resistance high capacity electrode structures in both super capacitors and next generation battery designs. The present compositions are also useful in making a freestanding graphitic carbon sheet. As used herein, the term “MX layer” or “layer of MX” refers to a layer comprising MX moieties, where M is one or more of titanium, hafnium or zirconium, and X is one or more of nitrogen, sulfur, selenium or oxygen, and preferably oxygen.

The present compositions comprise a liquid carrier. Suitable liquid carriers are easily determined by one skilled in the art. Preferably, the liquid carrier is an organic solvent or mixture of organic solvents. Suitable organic solvents include, without limitation, aliphatic hydrocarbons (e.g., dodecane, tetradecane); aromatic hydrocarbons (e.g., benzene, toluene, xylene, trimethylbenzene, butyl benzoate, dodecylbenzene); ketones (e.g., methyl ethyl ketone, methyl isobutyl ketone, cyclohexanone); esters (e.g., 2-hydroxyisobutyric acid methyl ester, γ-butyrolactone, ethyl lactate); ethers (e.g., tetrahydrofuran, 1,4-dioxaneandtetrahydrofuran, 1,3-dioxalane); glycol ethers (e.g., diprolylene glycol dimethyl ether); alcohols (e.g., 2-methyl-1-butanol, 4-ethyl-2-pentol, 2-methoxy-ethanol, 2-butoxyethanol, methanol, ethanol, isopropanol, α-terpineol, benzyl alcohol, 2-hexyldecanol); glycols (e.g., ethylene glycol) and mixtures thereof. Preferred liquid carriers include toluene, xylene, trimethylbenzene, alkylnaphthalenes, 2-methyl-1-butanol, 4-ethyl-2-pentol, γ-butyrolactone, ethyl lactate, 2-hydroxyisobutyric acid methyl ester, propylene glycol methyl ether acetate and propylene glycol methyl ether. Preferably, the liquid carrier contains less than 10,000 ppm of water. More preferably, the liquid carrier in the coating composition used in the method of the present invention, contains less than 5000 ppm water. Most preferably, the liquid carrier in the coating composition used in the method of the present invention, contains less than 2500 ppm water.

The present compositions also comprise one or more MX/graphitic carbon precursors of formula (1)

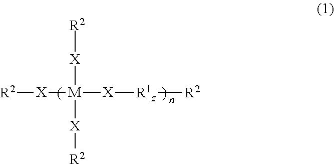

wherein each M is selected from the group consisting of Ti, Hf and Zr; each X is independently selected from the group consisting of N(R), S, Se and O; each R is selected from the group consisting of H and a —C₁₋₁₀ hydrocarbyl group; each R¹ is a —C₂₋₆ alkylene-X— group; z is 0 to 5; n is 1 to 15; each R² is independently selected from the group consisting of a hydrogen, a —C₁₋₂₀ organic residue, a —C(O)—C₁₋₂₀ hydrocarbyl group, and a —(Y¹)ₐ-(L¹)_{b}-(Y²)_{c}-(L²)_{d}-C₁₀₋₆₀ polycyclic aromatic moiety; each Y¹ and Y² is independently selected from the group consisting of —C(O)— and —S(O)₂—; each L¹ and L² is independently a —C₁₋₁₀ hydrocarbyl group; a=0 or 1; b=0 or 1; c=0 or 1; and d=0 or 1; provided that d=0 when c=0; wherein at least one of b and d=1 when Y¹═—C(O)— or when a=c=0; and wherein at least 10 mol % of the R² groups in the MX/graphitic carbon precursor material are —(Y¹)ₐ-(L¹)_{b}-(Y²)_{c}-(L²)_{d}-C₁₀₋₆₀ polycyclic aromatic moieties. In one preferred embodiment, the MX/graphitic carbon precursors of formula (1) comprises a mixture of two or more selected from the group consisting of Ti, Hf, and Zr. In another embodiment, it is preferred that each M is the same. It is preferred that each M is selected from Hf and Zr, and more preferably each M=Zr. Preferably, each X is independently selected from N, S and O; more preferably from S and O; and most preferably each X is O. It is preferred that n is 2 to 12, more preferably 2 to 8, and most preferably 2 to 4. Preferably, z is 0 to 4, more preferably 0 to 2, and most preferably z=0. It is preferred that each R is independently H or a —C₁₋₈ hydrocarbyl group, and more preferably H or a —C₁₋₆ hydrocarbyl group. It is preferred that each R¹ is a —C₂₋₄ alkylene-X— group; and more preferably a —C₂₋₄ alkylene-O— group. Preferably, each R² is independently selected from the group consisting of hydrogen, a —C₁₋₁₀ organic residue; a —C(O)—C₁₋₁₀ hydrocarbyl group, and a —(Y¹)ₐ-(L¹)_{b}-(Y²)_{c}-(L²)_{d}-C₁₀₋₆₀ polycyclic aromatic moiety. More preferably, each R² is independently selected from the group consisting of hydrogen, —C₁₋₁₀-alkyl, —C₁₋₁₀ alkylene-C(O)—O—C₁₋₆-alkyl, —C(O)—C₁₋₁₀-alkyl, a β-diketone residue, a β-hydroxyketone residue, —C(O)—C₆₋₁₀ alkylaryl group, a substituted —C(O)—C₆₋₁₀ arylalkyl group, a —C(O)—C₆ aryl group, a substituted —C(O)—C₆ aryl group, and a —(Y¹)ₐ-(L¹)_{b}-(Y²)_{c}-(L²)_{d}-C₁₀₋₆₀ polycyclic aromatic moiety. Y¹ is preferably —C(O)—. Each of L¹ and L² is preferably selected from the group consisting of a chemical bond (i.e., when b=0 or d=0, respectively), —C₁₋₁₀-alkylene, substituted —C₁₋₁₀-alkylene, —C₂₋₁₀-alkenylene, substituted —C₂₋₁₀-alkenylene, phenylene (—C₆H₄—), —C(R⁴)₂—C₆H₄—, —C₂(R⁴)₄—C₆H₄—, —C(R⁴)₂—C₆H₄—C(R⁴)₂—, and —C₂(R⁴)₅—C₆H₄—C₂(R⁴)₄—; wherein each R⁴ is independently chosen from H and —C₁₋₄-alkyl. Preferably, each R⁴ is chosen from H or methyl, and more preferably H. Preferably, L¹ is a chemical bond (i.e., b=0), —C₁₋₆-alkylene, —C₂₋₆-alkenylene, or substituted —C₂₋₆-alkenylene. It is preferred that L² is a chemical bond (i.e., d=0) or —C₁₋₆-alkylene, and more preferably a chemical bond. By “substituted —C₁₋₁₀-alkylene” is meant a —C₁₋₁₀-alkylene having one or more of its hydrogens replaced with one or more substituents selected from the group consisting of halogen, cyano and —C₁₋₁₀-alkoxy. Likewise, by the term “substituted —C₁₋₁₀-alkenylene” is meant a —C₁₋₁₀-alkenylene having one or more of its hydrogens replaced with one or more substituents selected from the group consisting of halogen, cyano and —C₁₋₁₀-alkoxy. In formula (1), a+b+c+d=1 to 4. When Y¹═—C(O)—, then b=1. When Y¹═—S(O)₂—, then b=0 or 1. Preferably, one of a, b, and c=1, that is a+b+c=1 to 3. It is preferred that b=1. Preferably, d=0. More preferably, b=1 and d=0. Preferably, when a=0, then b=1, c=0, and d=0. More preferably, when a=0, b=1, c=0, d=0, and L¹=—C₁₋₆-alkylene. It is preferred that c=0 when a=0. When any of a, b, c, and d=0, then a single covalent chemical bond is inferred. More preferably, the present MX/graphitic carbon precursors have a chemical structure according to formula (I), wherein 10 to 95 mol %, yet more preferably 25 to 90 mol %, and still more preferably 30 to 85 mol %, of the R² groups are —(Y¹)ₐ-(L¹)_{b}-(Y²)_{c}-(L²)_{d}-C₁₀₋₆₀ polycyclic aromatic moieties.

Each MX/graphitic carbon precursor of formula (1) may have a single R² group, but will typically have a plurality of R² groups, and preferably has a plurality of R² groups, provided that at least 10 mol % of the R² groups is a —(Y¹)ₐ-(L¹)_{b}-(Y²)_{c}-(L²)_{d}-C₁₀₋₆₀ polycyclic aromatic moiety. Preferred MX/graphitic carbon precursors of formula (1) have a mixture of two or more different R² groups, and more preferably three or more different R² groups, where at least 10 mol % of the R² groups is a —(Y¹)ₐ-(L¹)_{b}-(Y²)_{c}-(L²)_{d}-C₁₀₋₆₀ polycyclic aromatic moiety. It is preferred that each MX/graphitic carbon precursor of formula (1) has two or more, and preferably three or more, different R² groups selected from the group consisting of hydrogen, a —C₁₋₂₀ organic residue, a —C(O)—C₁₋₂₀ hydrocarbyl group, and a —(Y¹)ₐ-(L¹)_{b}-(Y²)_{c}-(L²)_{d}-C₁₀₋₆₀ polycyclic aromatic moiety, provided that at least 10 mol % of the R² groups is a —(Y¹)ₐ-(L¹)_{b}-(Y²)_{c}-(L²)_{d}-C₁₀₋₆₀ polycyclic aromatic moiety. Suitable —C₁₋₂₀ organic residues are —C₁₋₂₀ alkyl groups and —C₁₋₁₀-alkylene-C(O)—O—C₁₋₁₀ alkyl, preferably —C₁₋₁₀ alkyl groups and —C₁₋₆-alkylene-C(O)—O—C₁₋₆ alkyl groups, more preferably —C₁₋₆ alkyl groups and —C₁₋₄-alkylene-C(O)—O—C₁₋₄ alkyl groups, and yet more preferably —C₄ alkyl and C₂-alkylene-C(O)—O—C₂H₅. Exemplary —C₁₋₂₀ organic residues include, without limitation, ethyl, propyl, butyl, pentyl, hexyl, octyl, decyl, and ethyl 2-yl-propionate (ethyl lactate). Suitable —C(O)— C₁₋₂₀ hydrocarbyl groups are —C(O)—C₁₋₂₀ alkyl groups, preferably —C(O)—C₁₋₁₀ alkyl groups, more preferably —C(O)—C₄₋₁₀ alkyl groups, yet more preferably —C(O)—C₆₋₁₀ alkyl groups, and still more preferably —C(O)—C₂ alkyl group. Exemplary —C(O)—C₁₋₂₀ alkyl groups include, but are not limited to, hexanoyl, octanoyl, decanoyl, and dodecanoyl. Preferably, 10 to 95 mol %, more preferably 25 to 90 mol %, and yet more preferably 30 to 85 mol %, of the R² groups in formula (1) are —(Y¹)ₐ-(L¹)_{b}-(Y²)_{c}-(L²)_{d}-C₁₀₋₆₀ polycyclic aromatic moieties. More preferably, at least 20 mol %, even more preferably at least 25 mol %, and yet more preferably at least 30 mol % of the R² groups in formula (1) are —(Y¹)ₐ-(L¹)_{b}-(Y²)_{c}-(L²)_{d}-C₁₀₋₆₀ polycyclic aromatic moieties. It is preferred that at least 20 mol % (more preferably at least 25 mol %, yet more preferably at least 30 mol %) of the R² groups in formula (1) are hydrogen or —C₁₋₂₀ organic residues, and preferably are selected from hydrogen, —C₁₋₂₀ alkyl groups and —C₁₋₁₀-alkylene-C(O)—O—C₁₋₁₀ alkyl groups. It is preferred that 20 to 75 mol % (more preferably 25 to 70 mol %, and yet more preferably 30 to 70 mol %) of the R² groups in formula (1) are hydrogen or —C₁₋₂₀ organic residues. Preferably, at least 30 mol % (more preferably at least 40 mol %, still more preferably at least 45 mol %) of the R₂ groups in formula (1) are —C(O)—C₁₋₂₀ hydrocarbyl groups, and more preferably —C(O)—C₁₋₂₀ alkyl groups. More preferably 30 to 70 mol %, yet more preferably 40 to 70 mol %, and even more preferably 45 to 70 mol %, of the R² groups are C(O)—C₁₋₂₀ hydrocarbyl groups. Preferred MX/graphitic carbon precursors of formula (1) are those wherein at least 10 mol % of the R² groups are —(Y¹)ₐ-(L¹)_{b}-(Y²)_{c}-(L²)_{d}-C₁₀₋₆₀ polycyclic aromatic moieties, at least 20 mol % of the R² groups are hydrogen or —C₁₋₂-organic residues, and at least 45 mol % of the R² groups are —C(O)—C₁₋₁₀-alkyl groups. More preferred MX/graphitic carbon precursors of formula (1) are those wherein at least 20 mol % of the R² groups are —(Y¹)ₐ-(L¹)_{b}-(Y²)_{c}(L²)_{d}-C₁₀₋₆₀ polycyclic aromatic moieties, at least 25 mol % of the R² groups are hydrogen or —C₁₋₂-organic residues, and at least 45 mol % of the R² groups are —C(O)—C₁₋₁₀-alkyl groups.

A wide variety of —C₁₀₋₆₀ polycyclic aromatic moieties may suitably be used in R² in the MX/graphitic carbon precursors of formula (1). By “polycyclic aromatic” moieties or groups is meant any aromatic moiety or group having two or more fused aromatic rings. The selection of such C₁₀₋₆₀ polycyclic aromatic moieties is within the ability of those skilled in the art, and includes unsubstituted C₁₀₋₆₀ polycyclic aromatic moieties and substituted —C₁₀₋₆₀ polycyclic aromatic moieties. A “substituted C₁₀₋₆₀ polycyclic aromatic moiety” refers to a C₁₀₋₆₀ polycyclic aromatic moiety having one or more of its aromatic hydrogens replaced with one or more substituents selected from the group consisting of —C₆₋₃₀-aryl, —C₁₋₁₀-alkoxy, —C₁₋₁₀-alkoxy, hydroxy-C₁₋₁₀-alkyl, cyano, halo, hydroxy, and —N(R⁵)₂; wherein each R⁵ is independently chosen from H, —C₁₋₁₀-alkyl, —C₆ aryl, and —C₇₋₁₀ aralkyl. It is preferred that each R⁵ is independently chosen from H and —C₁₋₁₀-alkyl. Preferably, a substituted —C₁₀₋₆₀ polycyclic aromatic moiety has one or more of its aromatic hydrogens replaced with one or more substituents selected from the group consisting of —C₆₋₃₀-aryl, —C₁₋₁₀-alkyl, —C₁₋₁₀-alkoxy, hydroxy-C₁₋₁₀-alkyl, cyano, and halo; and more preferably one or more of its aromatic hydrogens replaced with one or more substituents selected from the group consisting of —C₆₋₁₂-aryl such as phenyl, naphthyl, and biphenyl; —C₁₋₈-alkyl; and —C₁₋₈-alkoxy. Suitable unsubstituted and substituted C₁₀₋₆₀ polycyclic aromatic moieties include, without limitation: naphthyl; methoxynaphthyl; ethoxynaphthyl; phenyl-naphthyl; anthracenyl; pyrenyl; tetracenyl; perylenyl; coronenyl; pentacenyl; triphenylenyl; tetraphenyl; benzotetracenyl; and binaphthyl, each of which may be optionally substituted as described above.

Exemplary R² groups of the formula —(Y¹)ₐ-(L¹)_{b}-(Y²)_{c}-(L²)_{d}-C₁₀₋₆₀ polycyclic aromatic moieties those groups of formulae (2a) to (2q), where “*” indicates the point of attachment.

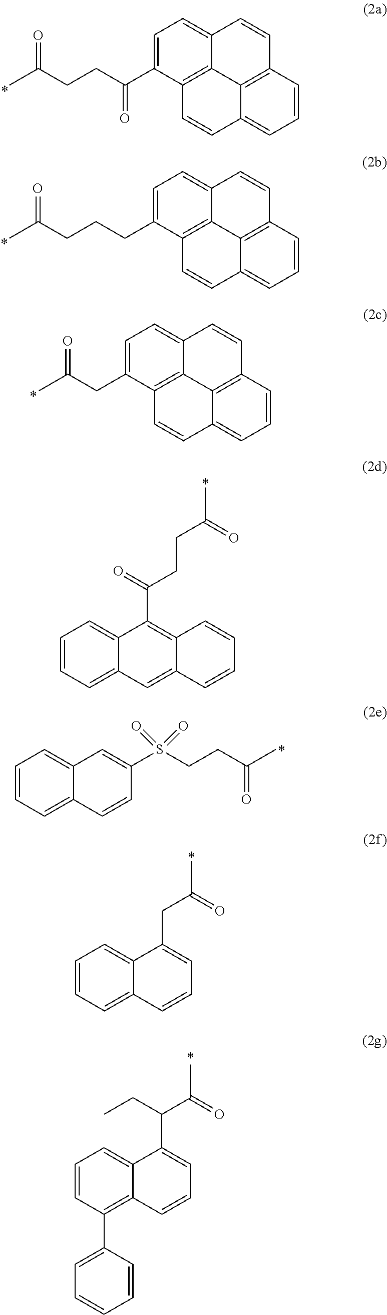

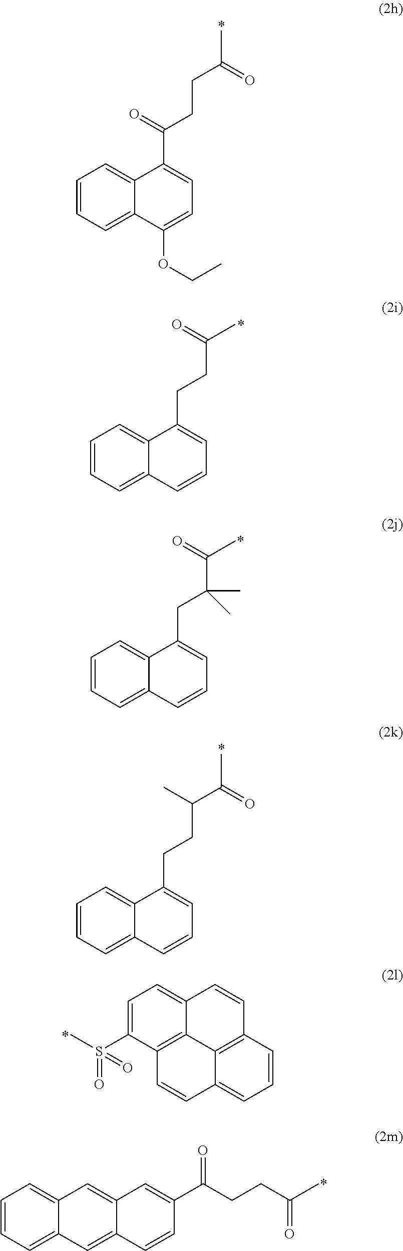

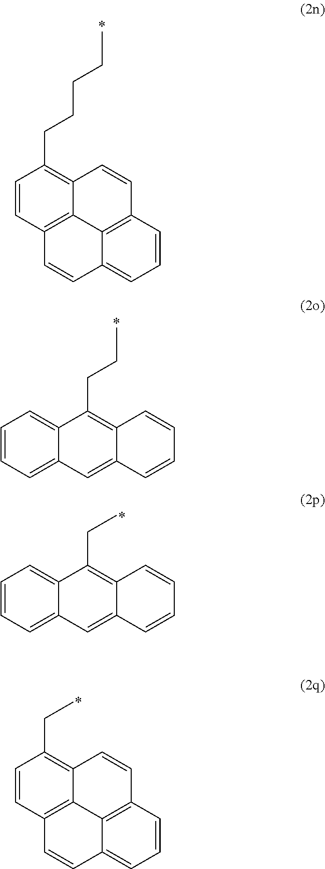

C₁₀₋₆₀ polycyclic aromatic compounds useful for forming the R² groups of the formula —(Y¹)ₐ-(L¹)_{b}-(Y²)_{c}-(L²)_{d}-C₁₀₋₆₀ polycyclic aromatic moieties in formula (1) include, without limitation: γ-oxo-1-pyrenebutyric acid; γ-oxo-1-pyrenebutyric acid; γ-oxo-1-pyrenebutyric acid; 4-anthracen-9-yl-4-oxo-butyric acid; 3-(naphthalene-2-sulfonyl)-propionic acid; 1-naphthaleneacetic acid; 2-(5-phenyl-1-naphthyl)butanoic acid; 4-(4-ethoxy-1-naphthyl)-4-oxobutanoic acid; 3-naphthalen-1-yl-propionic acid; 2,2-dimethyl-3-(1-naphthyl)propanoic acid; 2-methyl-4-naphthalen-1-yl-butyric acid; 1-pyrenesulfonic acid; 4-anthracen-2-yl-4-oxo-butyric acid; 2-(9-anthryl)ethanol; 9-anthracenemethanol; 1-pyrenemethanol; 1-pyrenebutanol; and mixtures thereof.

Preferred MX/graphitic carbon precursors of formula (1) are those wherein each M is Hf or Zr; each X is O; n is 1 to 15 (preferably, 2 to 12; more preferably, 2 to 8; most preferably, 2 to 4); each R¹ is —C₂₋₆ alkylene-O— group (preferably, R¹ is —C₂₋₄ alkylene-O— group); z is 0 to 5 (preferably, 0 to 4; more preferably, 0 to 2; most preferably, 0); each R² group is independently selected from the group consisting of a hydrogen, a —C₁₋₂₀ alkyl group, a —C(O)—C₂₋₃₀ alkyl group, a —C(O)—C₆₋₁₀ alkylaryl group, a —C(O)—C₆₋₁₀ arylalkyl group, a —C(O)—C₆ aryl group and a —(Y¹)ₐ-(L¹)_{b}-(Y²)_{c}-(L²)_{d}-C₁₀₋₆₀ polycyclic aromatic moiety; wherein at least 10 mol % (preferably 10 to 95 mol %, more preferably 25 to 90 mol %, and even more preferably 30 to 85 mol %) of the R² groups in the MX/graphitic carbon precursor material are —(Y¹)ₐ-(L¹)_{b}-(Y²)_{c}-(L²)_{d}-C₁₀₋₆₀ polycyclic aromatic moieties. More preferably, the R² groups in the MX/graphitic carbon precursor material are selected from the group consisting of formulae (2a) to (2q), and more preferably (2a) or (2d). More preferably, each M is Zr. Even more preferably, each M is Zr and z=0.

Other preferred MX/graphitic carbon precursors of formula (1) are those wherein each M is Zr; each X is O; n is 1 to 15 (preferably, 2 to 12; more preferably, 2 to 8; most preferably, 2 to 4); each R¹ is —C₂₋₆ alkylene-O— group (preferably, R¹ is —C₂₋₄ alkylene-O— group); z=0; each R² group is independently selected from the group consisting of a hydrogen, a —C₁₋₂₀ alkyl group, a —C(O)—C₂₋₃₀ alkyl group, a —C(O)—C₆₋₁₀ alkylaryl group, a —C(O)—C₆₋₁₀ arylalkyl group, a —C(O)—C₆ aryl group, and a —(Y¹)ₐ-(L¹)_{b}-(Y²)_{c}-(L²)_{d}-C₁₀₋₆₀ polycyclic aromatic moiety; wherein at least 10 mol % of the R² groups are —(Y¹)ₐ-(L¹)_{b}-(Y²)_{c}-(L²)_{d}-C₁₀₋₆₀ polycyclic aromatic moieties, at least 20 mol % of the R² groups are —C₁₋₁₀-alkyl groups, and at least 45 mol % of the R² groups are —C(O)—C₁₋₁₀-alkyl groups.

The present coating compositions comprise: a liquid carrier; and one or more MX/graphitic carbon precursors of formula (1) as described above. Preferably, the coating compositions comprise 1 to 25 wt % of the MX/graphitic carbon precursor. More preferably, the present coating compositions comprise 1 to 20 wt %, and even more preferably 1 to 16 wt %, of the MX/graphitic carbon precursor material. In the present coating compositions, the balance of the composition is the liquid carrier.

The present coating compositions may further comprise one or more optional additives, such as, but not limited to, curing catalysts, antioxidants, dyes, contrast agents, binder polymers, rheology modifies and surface leveling agents. The choice of the amount of such optional additives is within the ability of those skilled in the art, but is typically in the range of 0 to 20 wt %, and preferably from 0.1 to 15 wt %. Depending on the application, it may be desirable to add one or more curing catalysts to the present compositions to aid in the curing of the matrix precursor material and/or the oxymetal precursor material. Exemplary curing catalysts include thermal acid generators (TAGs) and photoacid generators (PAGs). TAGs and their use are well-known in the art. Examples of TAGs include those sold by King Industries, Norwalk, Conn., USA under NACURE™, CDX™ and K-PURE™ names. Photoacid generators (PAGs) and their use are well-known in the art and are activated upon exposure to a suitable wavelength of light or upon exposure to a beam of electrons (e-beam) to generate an acid. Suitable PAGs are available from a variety of sources, such as from BASF (Ludwigshafen, Germany) under the IRGACURE™ brand. A wide variety of binder polymers may be used, such as to provide improved coating quality or leveling over the substrate, particularly when the matrix precursor material is an organometallic material. Suitable binder polymers are disclosed in U.S. patent application Ser. No. 13/776,496.

The MX/graphitic carbon precursor material of formula (1) may be readily prepared by a variety of methods known in the art, such as those disclosed in U.S. Pat. Nos. 8,795,774; 8,927,439; and 9,171,720. Typically, a ligand exchange reaction between a starting metal compound of the formula M^{+m}Xₘ, where X is a ligand to be exchanged, such as C₁₋₆ alkoxy or —C₅₋₂₀ β-diketonate. In a general procedure, the starting metal compound is first partially condensed by reacting the starting metal compound with an amount of water in an organic solvent at a suitable temperature, such as from room temperature to 80° C., for a suitable period of time, such as 2 hours. After this partial condensation step, a portion of the starting ligands may be hydrolyzed and replaced with OH groups and/or a residue of the organic solvent if the organic solvent has an active functional group such as hydroxyl. Next, the partial condensate is combined with one or more desired ligands and a suitable organic solvent in a flask. The mixture is then heated, typically from room temperature to 80° C. or higher, for a period of time to allow the desired ligand exchange to occur. Following this procedure, 1, 2 or all 3 of the C₁₋₆ alkoxy or —C₅₋₂₀ β-diketonate starting ligands on the starting metal compound may be exchanged with a corresponding number of desired ligands. It will be appreciated by those skilled in the art that the number of —C₁₋₆ alkoxy or —C₅₋₂₀ β-diketonate starting ligands replaced will depend on the steric hindrance of the particular starting ligand, the steric hindrance of the desired new ligand used, and the length of time the mixture is heated, with increasing length of time providing for greater ligand exchange.

Coating compositions of the invention may be prepared by combining the liquid carrier and one or more of the MX/graphitic carbon precursor materials of formula (1) in any order. The coating compositions may be used as is, or may be purified prior to use. For example, such coating compositions may be filtered, such as through a polytetrafluoroethylene membrane, or contacted with an ion exchange resin, or both, prior to being disposed on a substrate. Such purification techniques are well-known in the art.

The present coating compositions may be disposed on any suitable substrate by any suitable means, such as spin-coating, slot-die coating, doctor blading, curtain coating, roller coating, spray coating, dip coating, and the like, to form a composite. Spin-coating and slot-die coating are preferred. In a typical spin-coating method, the present compositions are applied to a substrate which is spinning at a rate of 500 to 4000 rpm for a period of 15 to 90 seconds. It will be appreciated by those skilled in the art that the total height of the deposited layer may be adjusted by changing the spin speed, as well as the percentage of solids in the composition.

A wide variety of substrates may be used in the present invention, provided such substrates can withstand the annealing temperatures used, e.g. 900-1000° C. Such substrates may be conductive or non-conductive. Suitable electronic device substrates include, without limitation: packaging substrates such as multichip modules; flat panel display substrates; semiconductor wafers; polycrystalline silicon substrates; and the like. Such substrates are typically composed of one or more of silicon, polysilicon, silicon oxide, silicon nitride, silicon oxynitride, silicon germanium, gallium arsenide, aluminum, sapphire, tungsten, titanium, titanium-tungsten, nickel, copper, gold, glass, or organic or inorganic coated glass. Suitable substrates may be in the form of wafers. Such substrates may be any suitable size. Preferred wafer substrate diameters are 200 mm to 300 mm, although wafers having smaller and larger diameters may be suitably employed

After coating a layer of the present composition on a substrate to form a composite, the coating layer is optionally baked. Preferably, the composite is baked. The composite can be baked during or after deposition of the coating composition on the substrate. More preferably, the composite is baked after disposing the coating composition on the substrate to form the composite. Preferably, the method of making a multilayer structure of the present invention, further comprises: baking the composite in air under atmospheric pressure. Preferably, the composite is baked at a baking temperature of ≤125° C. More preferably, the composite is baked at a baking temperature of 60 to 125° C. Most preferably, the composite is baked at a baking temperature of 90 to 115° C. Preferably, the composite is baked for a period of 10 seconds to 10 minutes. More preferably, the composite is baked for a baking period of 30 seconds to 5 minutes. Most preferably, the composite is baked for a baking period of 6 to 180 seconds. Preferably, when the substrate is a semiconductor wafer, the baking can be performed by heating the semiconductor wafer on a hot plate or in an oven.

The composite is annealed in the presence of a reducing atmosphere. In general, the composite is annealed at a temperature of ≥150° C. More preferably, the composite is annealed at an annealing temperature of 450° C. to 1500° C. Most preferably, the composite is annealed at an annealing temperature of 700 to 1000° C. Preferably, the composite is annealed at the annealing temperature for an annealing period of 10 seconds to 2 hours. More preferably, the composite is annealed at the annealing temperature for an annealing period of 1 to 60 minutes. Most preferably, the composite is annealed at the annealing temperature for an annealing period of 10 to 45 minutes. Such annealing is performed under a reducing atmosphere, such as under a forming gas atmosphere. Preferably, the forming gas atmosphere comprises hydrogen in an inert gas. Preferably, the forming gas atmosphere is hydrogen in at least one of nitrogen, argon and helium. More preferably, the forming gas atmosphere is 2 to 5.5 vol % hydrogen in at least one of nitrogen, argon and helium. Most preferably, the forming gas atmosphere is 5 vol % hydrogen in nitrogen.

In the process of making a multilayer structure of the present invention, the multilayer structure provided is an MX layer and a graphitic carbon layer disposed on the substrate, wherein the MX layer is interposed between the substrate and the graphitic carbon layer in the multilayer structure. More preferably, the multilayer structure provided is a metal oxide layer and a graphitic carbon layer disposed on the substrate, wherein the metal oxide layer is interposed between the substrate and the graphitic carbon layer in the multilayer structure. Preferably, the graphitic carbon layer is a graphene or graphene oxide layer, and more preferably a graphene oxide layer. Preferably, the graphitic carbon layer is a graphene oxide layer having a carbon to oxygen (C/O) molar ratio of 1 to 10.

In another preferred embodiment, the present method of making a multilayer structure of the present invention further comprises disposing the coating composition on top of the previously provided multilayer structure, wherein a plurality of alternating MX layers (preferably, metal oxide layers) and graphitic carbon layers are disposed on the substrate. This results in a cured structure having an alternating structure of cured MX layers (preferably, metal oxide layers) and graphitic carbon layers. This process may be repeated any number of times to build a desired stack of such alternating layers.

The present invention also provides a method of making a freestanding graphitic carbon sheet. To obtain a freestanding graphitic carbon sheet, the multilayer structure described above is exposed to an acid, such as a mineral acid, and preferably hydrofluoric acid, such as by immersing the multilayer structure in an acid bath. Next, the freestanding graphitic carbon sheet is recovered. One of ordinary skill in the art will know how to recover the graphitic carbon sheet following exposure of the multilayer structure to an acid. Most preferably, the method of making a freestanding graphitic carbon sheet of the present invention, comprises: exposing the multilayer structure to an acid bath (preferably, an inorganic acid bath; more preferably, a hydrofluoric acid bath), wherein the multilayer structure is immersed in the acid bath, whereby the MX layer (preferably, the metal oxide layer) is etched away and wherein the graphitic carbon layer floats to a surface of the acid bath and is recovered from the surface of the acid bath as a free standing graphitic carbon sheet.

The multilayer structures produced by the method of the present invention are useful in a variety of applications, including as components in electronic devices, in electric storage systems (e.g., as energy storage components of supercapacitors; as electrodes in lithium ion batteries) and as barrier layers for impeding water and/or oxygen permeation. The present MX/graphitic carbon precursor materials of formula (1) have good solubility in a variety of solvents used to deposit coating compositions in the art. Such good solubility also reduces coating defects, such as striations, during spin-coating of the compositions. The free standing graphitic carbon sheet produced by the method of the present invention are useful in a wide variety of applications. For example, the free stranding graphitic carbon sheets can be used as electrodes or electrode components in a variety of device applications including displays, electric circuits, solar cells, and electric storage system (e.g., as part of an electrode in a lithium ion battery; or a component in a capacitor).

### EXAMPLE 1—COMPOSITION 1

To a 100 mL, 2-neck, round bottom flask were added 30.067 g ethyl lactate, 14.298 g of a 80% tetrabutoxyzirconium in butanol, 3.631 g of a 10% by weight of water in ethyl lactate solution. The mixture was stirred while heating the flask to 60° C. Stirring was continued for 2 hours while the temperature was maintained at 60° C. Next, 6.906 g of octanoic acid and 4.839 g of [symbol] -oxy-1-pyrenebutyric acid were added to the reaction solution. The reaction temperature was again maintained at 60° C. for 2 hours with stirring. Following this reaction, some cloudiness was observed in the solution and thus 24.847 g of ethyl lactate was added to the reaction solution to dilute the material. After filtration through a 0.2 μm polytetrafluoroethylene (PTFE) filter, a nice dark brown colored solution was obtained. Using a weight loss method, this composition was found to contain 17.7% solids. Based on the ligands added, the metal oxide/graphitic carbon precursor material contained in the product coating composition was accorded the following formula

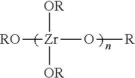

wherein n, the average number of repeat units, is approximately 3; wherein 60 mol % of the R groups (or 4.8 groups per oligomer) were —C(O)—C₇ alkyl groups (derived from octanoic acid); wherein 20 mol % of the R groups (or 1.6 groups per oligomer) were derived from [symbol] -oxy-1-pyrenebutyric acid; and wherein 20 mol % of the R groups (or 1.6 groups per oligomer) were —OC₄H₉ or derived from ethyl lactate or a combination thereof. The overall reaction is illustrated in Reaction Scheme 1.

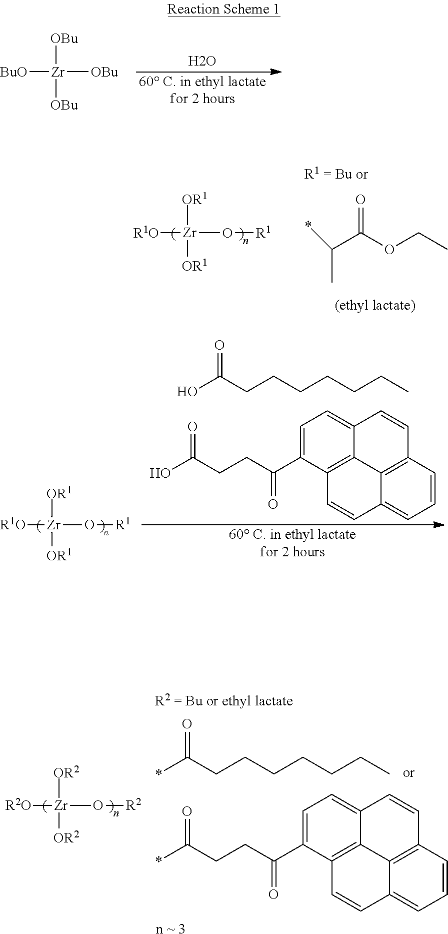

Weight Loss Method:

Approximately 0.1 g of the composition was weighed into a tared aluminum pan. Approximately 0.5 g of the liquid carrier (solvent, ethyl lactate) used to form the composition was added to the aluminum pan to dilute the test solution to make it cover the aluminum pan more evenly. The aluminum pan was heated in a thermal oven at approximately 110° C. for 15 minutes. After the aluminum pan cooled to room temperature, the weight of the aluminum pan with dried solid film was determined, and the percentage solid content was calculated.

### EXAMPLE 2

The filtered composition from Example 1 (1.045 g) was mixed with 4.932 g of ethyl lactate. After filtering the diluted solution multiple times through a 0.2 μm PTFE syringe filter, the coating composition was spin coated on a 200 mm silicon wafer at 1500 rpm to form a 632 Å film. The film was baked at 90° C. for 60 seconds. The coating quality of the film was excellent.

### EXAMPLE 3

The filtered composition from Example 1 (0.535 g) was mixed with 5.513 g of ethyl lactate. After filtering the diluted solution multiple times through a 0.2 μm PTFE syringe filter, the coating composition was spin coated on a 200 mm silicon wafer at 1500 rpm to form a 292 Å film. The film was baked at 90° C. for 60 seconds. The coating quality of the film was excellent.

### EXAMPLE 4

The coating composition of Example 1 is filtered through a 0.2 μm PTFE syringe filter four times before spin coating on a bare silicon wafers at 1500 rpm. After spin coating, the coating layer is baked at 100° C. for 60 seconds. The coated silicon oxide wafer is then cleaved into approximately 3.8 cm×3.8 cm wafer coupons. The coupons are then placed in an annealing vacuum oven. The wafer coupons are annealed under a reduced pressure of a forming gas (5 vol % H₂ in N₂) for 20 minutes at 900° C. using the following temperature ramping profile:

Ramp up: from room temperature to 900° C. over 176 minutes

Soak: maintain at 900° C. for 20 minutes

Ramp down: from 900° C. to room temperature over slightly longer than 176 minutes.

The coated surface of the wafer coupon post annealing is expected to have a shinning metallic appearance, and is expected to comprise a multilayer structure with an in situ formed metal oxide film directly on the surface of the wafer coupon interposed between the surface of the wafer coupon and an overlying graphitic carbon layer. Raman spectra of the graphitic carbon layers are expected to match well with literature graphene oxide spectra for single layer as well as 5-layer graphene oxide films.

### EXAMPLE 5—COMPOSITION 2

The general procedure of Example 1 is repeated except that the [symbol] -oxy-1-pyrenebutyric acid is replaced with an equivalent molar amount of 4-(anthracen-9-yl)-4-oxobutanoic acid, with similar results expected.

### EXAMPLE 6

The general procedure of Example 2 is repeated using Composition 2 from Example 5, with similar results expected.

### EXAMPLE 7—COMPOSITION 3

The procedure of Example 1 is repeated except that the tetrabutoxyzirconium is replaced with an equivalent molar amount of tetrabutoxyhafnium, with similar results expected.

### EXAMPLE 8

The general procedure of Example 2 is repeated using Composition 3 from Example 7, with similar results expected.

### EXAMPLE 9 COMPOSITIONS 4-11

The general procedure of Example 1 is repeated except that the tetrabutoxyzirconium (starting metal compound) and/or the [symbol] -oxy-1-pyrenebutyric acid (polycyclic aromatic ligand) are replaced with the materials reported in Table 1, with similar results expected. The following abbreviations are used in Table 1: Zr(Bu)₄=tetrabutoxyzirconium; Hf(Bu)₄=tetrabutoxyhafnium; and Ti(Bu)₄=tetrabutoxytitanium.

TABLE 1

| | Starting | |
|---|---|---|
| | Metal | |
| Composition | Compound | Polycyclic Aromatic Ligand |
| 4 | Zr(Bu)₄ | 3-(Naphthalene-2-ylsulfonyl)propanoic acid |
| 5 | Zr(Bu)₄ | Pyrene-1-sulfonic acid |
| 6 | Hf(Bu)₄ | 4-(Pyren-1-yl)butanoic acid |
| 7 | Hf(Bu)₄ | 4-(4-Ethoxynaphthalen-1-yl)-4-oxobutanoic |
| | | acid |
| 8 | Zr(Bu)₄ | 2-(Pyren-4-yl)ethan-1-ol |
| 9 | Hf(Bu)₄ | 4-(Anthacen-2-yl)-4-oxobutanoic acid |
| 10 | Ti(Bu)₄ | [symbol] -Oxy-1-pyrenebutyric acid |
| 11 | Zr(Bu)₄ | 2-(5-Phenylnaphthalen-1-yl)butanoic acid |

### EXAMPLE 10

A coated wafer coupon derived using the coating composition according of Example 2 is evaluated using a 4-probe resistivity measurement tool to measure the electric conductivity of the deposited multilayer structure. The carbon to oxygen (C/O) ratio for the deposited graphitic carbon layer is also determined using a surface XPS analysis.

### EXAMPLE 11

A coated wafer coupon is prepared using a 5 wt % solids coating composition from Example 1. The coated wafer is submersed in hydrofluoric acid. Upon submersion in the hydrofluoric acid, the graphitic carbon layer is expected to lift from the multilayer deposited film structure and isolated. The free standing graphitic carbon film is expected to be transparent and flexible. The freestanding graphitic carbon film is analyzed by x-ray diffraction spectroscopy.

What is claimed is:

1. A composition comprising: a liquid carrier; and one or more a MX/graphitic carbon precursors of the formula (1) 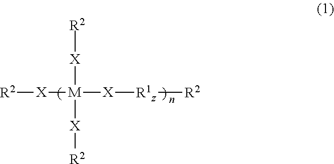
wherein each M is selected from the group consisting of Ti, Hf and Zr; each X is independently selected from the group consisting of N(R), S, Se and O; each R is selected from the group consisting of H and a —C₁₋₁₀ hydrocarbyl group; each R¹ is a —C₂₋₆ alkylene-X— group; z is 0 to 5; n is 1 to 15; each R² is independently selected from the group consisting of hydrogen, a —C₁₋₂₀ organic residue; a —C(O)—C₁₋₂₀ hydrocarbyl group, and a —(Y¹)ₐ-(L¹)_{b}-(Y²)_{c}-(L²)_{d}-C₁₀₋₆₀ polycyclic aromatic moiety; each Y¹ and Y² is independently selected from the group consisting of —C(O)— and —S(O)₂—; each L¹ and L² is independently a —C₁₋₁₀ hydrocarbyl group; a=0 or 1; b=0 or 1; c=0 or 1; and d=0 or 1; provided that d=0 when c=0; wherein at least one of b and d=1 when Y¹═—C(O)— or when a=c=0; and wherein at least 10 mol % of the R² groups in the MX/graphitic carbon precursor material are —(Y¹)ₐ-(L¹)_{b}-(Y²)_{c}-(L²)_{d}-C₁₀₋₆₀ polycyclic aromatic moieties.

2. The composition of claim 1 wherein M is Hf or Zr.

3. The composition of claim 1 wherein 25 to 90 mol % of the R² groups in the MX/graphitic carbon precursor material are —(Y¹)ₐ-(L¹)₆-(Y²)_{c}-(L²)_{d}-C₁₀₋₆₀ polycyclic aromatic moieties.

4. The composition of claim 1 wherein R² is independently selected from the group consisting of hydrogen, —C₁₋₁₀-alkyl, —C₁₋₁₀ alkylene-C(O)—O—C₁₋₆-alkyl, —C(O)—C₁₋₁₀-alkyl, a β-diketone residue, a β-hydroxyketone residue, —C(O)—C₆₋₁₀ alkylaryl group, a substituted —C(O)—C₆₋₁₀ arylalkyl group, a —C(O)—C₆ aryl group, a substituted —C(O)—C₆ aryl group, and a —(Y¹)ₐ-(L¹)_{b}-(Y²)_{c}-(L²)_{d}-C₁₀₋₆₀ polycyclic aromatic moiety

5. The composition of claim 1 wherein the C₁₀₋₆₀ polycyclic aromatic moieties are selected from the group consisting of: naphthyl; methoxynaphthyl; ethoxynaphthyl; phenyl-naphthyl; anthracenyl; pyrenyl; tetracenyl; perylenyl; coronenyl; pentacenyl; triphenylenyl; tetraphenyl; benzotetracenyl; and binaphthyl, each of which may be optionally substituted.

6. A method of forming a multilayer structure, comprising: providing a substrate; providing a coating composition, comprising: a liquid carrier and one or more MX/graphitic carbon precursors having a formula (1) 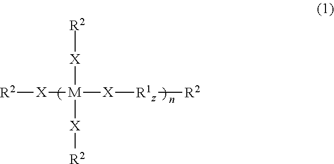
wherein each M is selected from the group consisting of Ti, Hf and Zr; each X is independently selected from the group consisting of N(R), S, Se and O; each R is selected from the group consisting of H and a —C₁₋₁₀ hydrocarbyl group; each R¹ is a —C₂₋₆ alkylene-X— group; z is 0 to 5; n is 1 to 15; each R² is independently selected from the group consisting of hydrogen, a —C₁₋₂₀ organic residue; a —C(O)—C₁₋₂₀ hydrocarbyl group, and a —(Y¹)ₐ-(L¹)_{b}-(Y²)_{c}-(L²)_{d}-C₁₀₋₆₀ polycyclic aromatic moiety; each Y¹ and Y² is independently selected from the group consisting of —C(O)— and —S(O)₂—; each L¹ and L² is independently a —C₁₋₁₀ hydrocarbyl group; a=0 or 1; b=0 or 1; c=0 or 1; and d=0 or 1; provided that d=0 when c=0; wherein at least one of b and d=1 when Y¹═—C(O)— or when a=c=0; and wherein at least 10 mol % of the R² groups in the MX/graphitic carbon precursor material are —(Y¹)ₐ-(L¹)_{b}-(Y²)_{c}-(L²)_{d}-C₁₀₋₆₀ polycyclic aromatic moieties; disposing the coating composition on the substrate to form a composite; optionally, baking the composite; annealing the composite under a reducing atmosphere; whereby the composite is converted into an MX layer and a graphitic carbon layer disposed on the substrate providing the multilayer structure; wherein the MX layer is interposed between the substrate and the graphitic carbon layer in the multilayer structure.

7. The method of claim 6 wherein M is Hf or Zr.

8. The method of claim 6 wherein 25 to 90 mol % of the R² groups in the MX/graphitic carbon precursor material are —(Y¹)ₐ-(L¹)_{b}-(Y²)_{c}-(L²)_{d}-C₁₀₋₆₀ polycyclic aromatic moieties.

9. The method of claim 6 wherein R² is independently selected from the group consisting of hydrogen, —C₁₋₁₀-alkyl, —C₁₋₁₀ alkylene-C(O)—O—C₁₋₆-alkyl, —C(O)—C₁₋₁₀-alkyl, a β-diketone residue, a β-hydroxyketone residue, —C(O)—C₆₋₁₀ alkylaryl group, a substituted —C(O)—C₆₋₁₀ arylalkyl group, a —C(O)—C₆ aryl group, a substituted —C(O)—C₆ aryl group, and a —(Y¹)ₐ-(L¹)_{b}-(Y²)_{c}-(L²)_{d}-C₁₀₋₆₀ polycyclic aromatic moiety

10. The method of claim 6 wherein the C₁₀₋₆₀ polycyclic aromatic moieties are selected from the group consisting of: naphthyl; methoxynaphthyl; ethoxynaphthyl; phenyl-naphthyl; anthracenyl; pyrenyl; tetracenyl; perylenyl; coronenyl; pentacenyl; triphenylenyl; tetraphenyl; benzotetracenyl; and binaphthyl, each of which may be optionally substituted.

11. A method of making a freestanding graphitic carbon sheet, comprising: providing a substrate; providing a coating composition, comprising: a liquid carrier and one or more MX/graphitic carbon precursors having a formula (1) 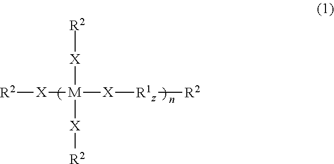
wherein each M is selected from the group consisting of Ti, Hf and Zr; each X is independently selected from the group consisting of N(R), S, Se and O; each R is selected from the group consisting of H and a —C₁₋₁₀ hydrocarbyl group; each R¹ is a —C₂₋₆ alkylene-X— group; z is 0 to 5; n is 1 to 15; each R² is independently selected from the group consisting of a hydrogen, a —C₁₋₂₀ organic residue; a —C(O)—C₁₋₂₀ hydrocarbyl group, and a —(Y¹)ₐ-(L¹)_{b}-(Y²)_{c}-(L²)_{d}-C₁₀₋₆₀ polycyclic aromatic moiety; each Y¹ and Y² is independently selected from the group consisting of —C(O)— and —S(O)₂—; each L¹ and L² is independently a —C₁₋₁₀ hydrocarbyl group; a=0 or 1; b=0 or 1; c=0 or 1; and d=0 or 1; provided that d=0 when c=0; wherein at least one of b and d=1 when Y¹═—C(O)— or when a=c=0; and wherein at least 10 mol % of the R² groups in the MX/graphitic carbon precursor material are —(Y¹)ₐ-(L¹)_{b}-(Y²)_{c}-(L²)_{d}-C₁₀₋₆₀ polycyclic aromatic moieties; disposing the coating composition on the substrate to form a composite; optionally, baking the composite; annealing the composite under a reducing atmosphere whereby the composite is converted into an MX layer and a graphitic carbon layer disposed on the substrate providing a multilayer structure; wherein the MX layer is interposed between the substrate and the graphitic carbon layer in the multilayer structure; exposing the multilayer structure to an acid; and, recovering the graphitic carbon layer as the freestanding graphitic carbon sheet.
